(19) United States
(12) Patent Application Publication
(10) Pub. No.: US 2026/0221872 A1
(43) Pub. Date: Jul. 30, 2026

(54) APPARATUS FOR CONTROLLING FLYING CAPACITOR VOLTAGE OF DIRECT-CURRENT TO DIRECT-CURRENT CONVERTER AND CONTROL METHOD THEREFOR

(71) Applicant: LS ELECTRIC CO., LTD., Anyang-si, Gyeonggi-do (KR)

(72) Inventors: Jae Ho LEE, Anyang-si, Gyeonggi-do (KR); Sun Ho BAE, Anyang-si, Gyeonggi-do (KR)

(21) Appl. No.: 19/147,612

(22) PCT Filed: Jan. 29, 2024
(86) PCT No.: PCT/KR2024/001365

§ 371 Date: Jul. 11, 2025

(30) Foreign Application Priority Data
Apr. 5, 2023 (KR) 10-2023-0044856

(51) Int. Cl. H02M 3/07; H02M 1/14; H02M 3/156

(52) U.S. Cl. CPC H02M 3/07; H02M 1/14; H02M 3/156

(57) ABSTRACT

The present disclosure relates to an apparatus and a method for controlling a flying capacitor voltage of a direct-current to direct-current converter. The present disclosure may change a voltage control value for controlling a switch according to a sign of an inductor current of the direct-current to direct-current converter, to thereby stably control a voltage of a flying capacitor even if the direction of the current is changed, and may reduce a control error even when the direct-current to direct-current converter has a light load.

### CROSS-REFERENCE TO RELATED APPLICATIONS

This application is a National Stage of International Application No. PCT/KR2024/001365, filed Jan. 29, 2024, which claims priority to and the benefit of Korean Patent Application No. 10-2023-0044856, filed Apr. 5, 2023, the disclosures of which are incorporated herein by reference in its entirety.

### FIELD

The present disclosure relates to a direct current-to-direct current (DC-DC) converter, and more specifically to a voltage control technique of a DC-DC converter including a flying capacitor.

### BACKGROUND

A converter is one of the representative power conversion devices along with an inverter. An inverter receives AC power, converts the same to DC, and then converts the same back to AC to control the motor. On the other hand, a converter, particularly a direct-current to direct-current (DC-DC) converter, is used to convert a low DC voltage to a higher DC voltage by using switches with relatively low rated voltages.

Converters used for charging electric vehicle batteries or solar power generation require DC-DC converters that can obtain very high voltages, and therefore, switches with high rated voltages must be used. However, the higher the rated voltage, the higher the size, weight and unit price, and thus, it is not easy to adopt these switches with high rated voltages.

In order to solve these problems, a DC-DC converter employing a flying capacitor has been proposed.

A DC-DC converter employing a flying capacitor can obtain a high output voltage with switches of relatively low rated voltage by connecting switches of relatively low rated voltage in series and connecting a flying capacitor between the switches.

In this case, the voltage of the flying capacitor must be adjusted to half of the output voltage. However, in the case of a bidirectional DC-DC converter, if the direction of the current is reversed, the voltage control loop changes to positive feedback, thereby causing a problem in which control becomes impossible.

In addition, proportional gain (P gain) is used to control the flying capacitor, but if an error in the proportional gain occurs or a voltage deviation occurs, a problem occurs in which the voltage of the flying capacitor does not converge to half of the output voltage.

The inventors of the present disclosure have made efforts to solve the problems of a DC-DC converter using the flying capacitor of the prior art. After much effort to enable the flying capacitor voltage control even when the direction of the current is reversed in a bidirectional DC-DC converter and to solve the problem of the flying capacitor voltage error caused by the proportional gain error, the inventors of the present disclosure have completed the present disclosure.

### NATIONAL RESEARCH AND DEVELOPMENT PROJECT THAT SUPPORTED THIS DISCLOSURE

[Project Identification Number] 1415181044
[Project Number] 20210501010020
[Name of Ministry] Ministry of Trade, Industry and Energy
[Name of Project Management (Specialized) Institution] Korea Institute of Energy Technology Evaluation and Planning
[Title of Research Project] Development of a large-capacity, high-voltage modular ESS technology for renewable energy power grid connection (R&D)
[Title of Research Task] MMC type ESS and renewable energy linked high-voltage hub station core apparatus development
[Contribution Ratio] 1/1
[Name of Project Executing Institution] Korea Electrotechnology Research Institute
[Research Period] Nov. 1, 2021 to Dec. 31, 2024

### SUMMARY

An object of the present disclosure is to provide an apparatus and method that are capable of more accurately controlling the voltage of a flying capacitor in a bidirectional flying capacitor DC-DC converter.

In addition, an object of the present disclosure is to solve a problem that the voltage control loop of the flying capacitor does not operate properly when the inductor current for power control is reversed.

Meanwhile, other unspecified objects of the present disclosure will be additionally considered within a range that can be easily inferred from the following detailed description and its effects.

The apparatus for controlling a flying capacitor voltage of a direct-current to direct-current (DC-DC) converter according to the present disclosure includes a voltage generation unit configured to generate an offset voltage by a difference between an output voltage of the DC-DC converter and a voltage of the flying capacitor; and a sign control unit configured to control a sign of an offset voltage generated by the voltage generation unit according to a sign of an inductor current of the DC-DC converter.

The sign control unit may multiply the offset voltage by 1 if the inductor current is 0 or more, and multiplies the offset voltage by −1 if the inductor current is less than 0.

The sign control unit may multiply the offset voltage by a value (i_{L}/I_{L1}) obtained by dividing the inductor current by the first inductor current if the inductor current is greater than or equal to a negative first inductor current value (−I_{L1}) and less than a positive first inductor current value (+I_{L1}), multiply the offset voltage by 1 if the inductor current is greater than or equal to +I_{L1}, and multiply the offset voltage by −1 if the inductor current is less than −I_{L1}.

The sign control unit may multiply the offset voltage by −\sqrt{−i_{L}/I_{L1}} if the inductor current (i_{L}) is greater than or equal to a negative first inductor current value (−I_{L1}) and less than or equal to 0, multiply the offset voltage by \sqrt{i_{L}/I_{L1}} if the inductor current is greater than 0 and less than a positive first inductor current value (I_{L1}), multiply the offset voltage by 1 if the inductor current is greater than or equal to +I_{L1}, and multiply the offset voltage by −1 if the inductor current is less than −I_{L1}.

The voltage generation unit may be composed of a proportional control device or a proportional-integral control device.

The method for controlling a flying capacitor voltage of a direct-current to direct-current (DC-DC) converter according to another embodiment of the present disclosure may include receiving an output voltage of the DC-DC converter and a voltage of the flying capacitor; generating an offset voltage by a difference between an output voltage of the DC-DC converter and a voltage of the flying capacitor; and adjusting a sign of the offset voltage according to a sign of an inductor current of the DC-DC converter.

The adjusting a sign of the offset voltage may multiply the offset voltage by 1 if the inductor current is greater than or equal to 0, and multiply the offset voltage by −1 if the inductor current is less than 0.

The adjusting a sign of the offset voltage may multiply the offset voltage by a value (i_{L}/I_{L1}) obtained by dividing the inductor current by the first inductor current if the inductor current is greater than or equal to a negative first inductor current value (−I_{L1}) and less than a positive first inductor current value (+I_{L1}), multiply the offset voltage by 1 if the inductor current is greater than or equal to +I_{L1}, and multiply the offset voltage by −1 if the inductor current is less than −I_{L1}.

The adjusting a sign of the offset voltage may multiply the offset voltage by −\sqrt{−i_{L}/I_{L1}} if the inductor current (i_{L}) is greater than or equal to a negative first inductor current value (−I_{L1}) and less than 0, multiply the offset voltage by \sqrt{i_{L}/I_{L1}} if the inductor current is greater than or equal to 0 and less than a positive first inductor current value (I_{L1}), multiply the offset voltage by 1 if the inductor current is greater than or equal to +I_{L1}, and multiply the offset voltage by −1 if the inductor current is less than −I_{L1}.

The generating an offset voltage may generate the offset voltage by a proportional control method or a proportional-integral control method.

According to the present disclosure, there is an effect of stably controlling the voltage of a flying capacitor even for reverse inductor current in a flying capacitor bidirectional DC-DC converter.

In addition, it is possible to obtain the advantage of reducing control instability due to measurement error caused by current ripple when a light load is connected to the output terminal of a DC-DC converter.

Meanwhile, it is added that even if an effect is not explicitly mentioned herein, the effect and its provisional effect described in the following specification expected by the technical features of the present disclosure are treated as described in the specification of the present disclosure.

### BRIEF DESCRIPTION OF THE DRAWINGS

FIG. 1 is a schematic structural diagram of a switch control circuit of a bidirectional DC-DC converter including an apparatus for controlling a flying capacitor voltage according to a preferred embodiment of the present disclosure.

FIGS. 2 and 3 are more detailed structural diagrams of an apparatus for controlling a flying capacitor voltage according to a preferred embodiment of the present disclosure.

FIG. 4 shows the relationship between an inductor current and an output sign for sign adjustment of an apparatus for controlling a flying capacitor voltage according to a preferred embodiment of the present disclosure.

FIG. 5 shows the main operating waveforms of a flying capacitor according to each mode according to a preferred embodiment of the present disclosure.

FIG. 6 shows an example of a controlled flying capacitor voltage graph according to a preferred embodiment of the present disclosure.

FIG. 7 is a schematic flowchart of the method for controlling a flying capacitor voltage of a DC-DC converter according to another preferred embodiment of the present disclosure.

FIG. 8 shows an example of a DC-DC converter with a typical flying capacitor applied.

FIG. 9 shows an example of a flying capacitor voltage control circuit according to the prior art.

※ It is stated that the attached drawings are provided as references to help understand the technical concept of the present disclosure, and the scope of the rights of the present disclosure is not limited thereby.

### DETAILED DESCRIPTION

Hereinafter, referring to the drawings, the configuration of the present disclosure and the effects resulting from the configuration will be examined as guided by various embodiments of the present disclosure. In terms of describing the present disclosure, if it is judged that the relevant known functions are obvious to those skilled in the art and may unnecessarily obscure the gist of the present disclosure, a detailed description thereof will be omitted.

The terms “first”, “second” and the like may be used to describe various components, but the components should not be limited by the terms. The terms may only be used to distinguish one component from another. For example, without departing from the scope of the present disclosure, the “first component” may be referred to as the “second component,” and similarly, the “second component” may also be referred to as the “first component.” In addition, singular expressions include plural expressions unless the context clearly indicates otherwise. The terms used in the embodiments of the present disclosure may be interpreted as having meanings commonly known to a person of ordinary skill in the art, unless otherwise defined.

Hereinafter, the configuration of the present disclosure and the effects resulting from the configuration will be described with reference to the drawings and various embodiments of the present disclosure.

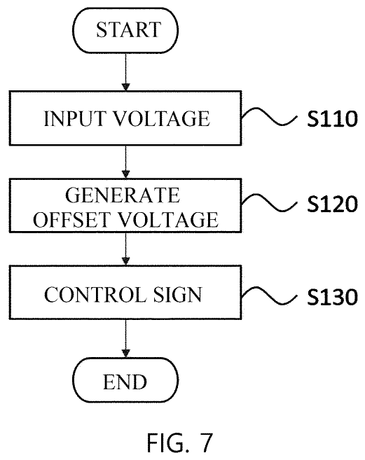

FIG. 8 shows an example of a DC-DC converter with a typical flying capacitor applied.

In the DC-DC converter of FIG. 8, a plurality of switches S₁, S′₁, S₂, S′₂ having relatively low rated voltages are connected in series, and a flying capacitor V_{F} is connected between the switches such that a high output voltage can be obtained by using switches having low rated voltages.

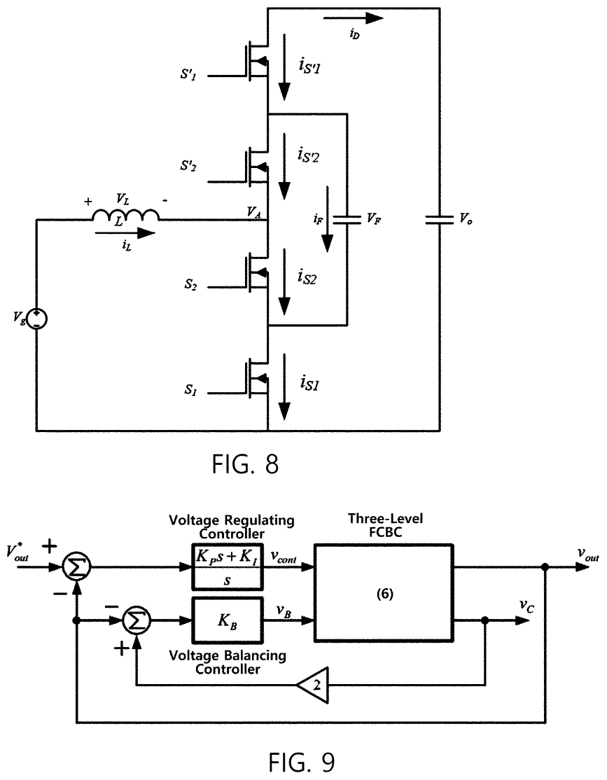

FIG. 9 shows an example of a flying capacitor voltage regulation circuit according to the prior art in a DC-DC converter using a flying capacitor.

In general, the voltage of the flying capacitor V_{C} is regulated to half of the output voltage Vₒᵤₜ. Therefore, a method has been used to regulate the voltage by comparing the voltage of the flying capacitor with a voltage corresponding to half of the output voltage, or by increasing or decreasing the voltage of the flying capacitor by comparing the output voltage with a voltage corresponding to twice the voltage of the flying capacitor as shown in FIG. 8.

In this case, the voltage transfer function of a flying capacitor is

$$\frac{{v}_{F}}{d} = \frac{{I}_{L}}{{sC}_{F}} ,$$

and if I_{L} is less than 0 when bidirectional power control is required, that is, when reverse current flows, the feedback loop for the flying capacitor changes to a feedforward loop, thereby causing a problem of the loss of control.

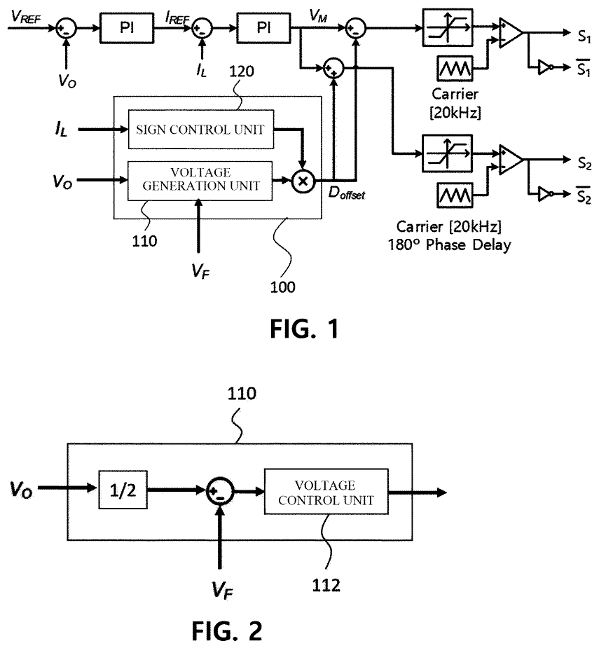

FIG. 1 shows an example of a voltage control circuit of a DC-DC converter according to the present disclosure for solving such a problem.

An apparatus 100 for controlling a flying capacitor voltage of a DC-DC converter according to the present disclosure may include a voltage generation unit 110 and a sign control unit 120.

The apparatus for controlling a flying capacitor voltage 100 receives the inductor current I_{L}, output voltage V_{O} and flying capacitor voltage V_{F} of the DC-DC converter and generates an offset voltage D_{offset} for the operating voltage V_{M}.

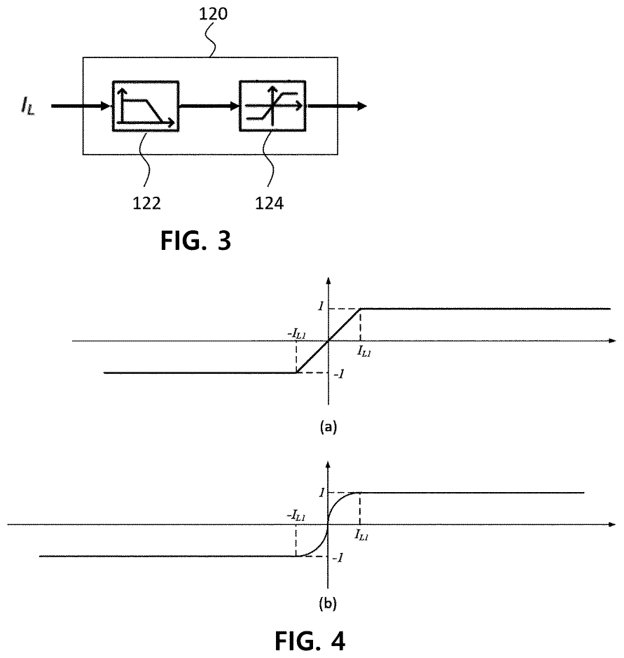

FIG. 2 is a more detailed structural diagram of a voltage generation unit according to the present disclosure.

The voltage generation unit 110 generates an offset voltage in the voltage control unit 112 by a difference between half of the output voltage V_{O} and the flying capacitor voltage V_{F}.

In the voltage control unit 112, the flying capacitor voltage V_{F} must be controlled to half of the output voltage V_{O}, and thus, an offset voltage is generated by a difference between half of the output voltage V_{O} and the flying capacitor voltage V_{F}.

The voltage control unit 112 may generate an offset voltage by using proportional control or proportional-integral control.

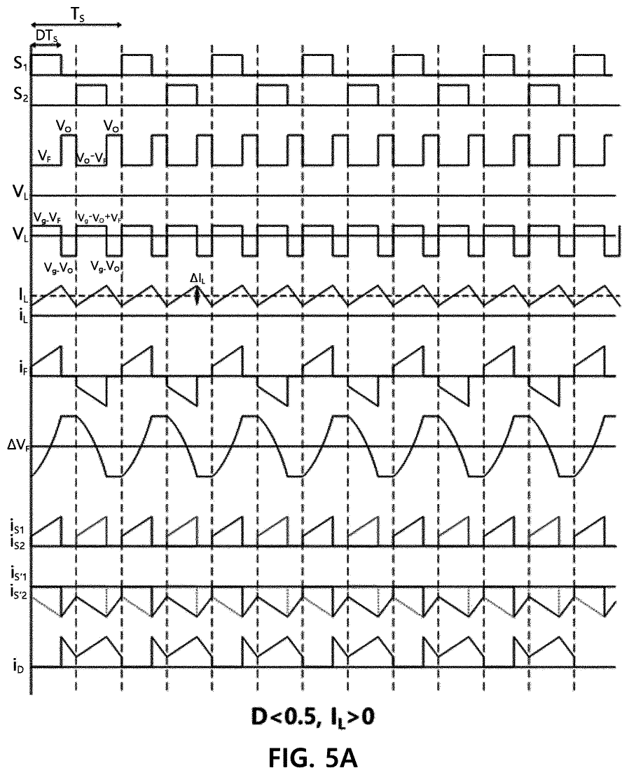

FIG. 3 is a more detailed structural diagram of a sign determination unit according to the present disclosure.

The sign determination unit 120 may be composed of a low-pass filter unit 122 and a sign calculation unit 124.

The low-pass filter unit 122 is composed of a low-pass filter (LPF) and may obtain the average value of the inductor current. The low-pass filter may have a bandwidth of 3 kHz, but is not limited thereto.

The sign calculation unit 124 determines the sign of an inductor current.

In the simplest form, the sign calculation unit 124 may use a sign(x) function, which determines the sign of a variable and outputs a value of 1 or −1. The sign(x) function outputs 1 if the value of x is positive and −1 if it is negative.

Therefore, in a bidirectional DC-DC capacitor, when the inductor current is less than 0, that is, when the direction of the inductor current is opposite, the sign calculation unit 124 adjusts the operating voltage value by converting the sign of the offset voltage generated by the voltage generation unit 110 to a negative value, and accordingly, the switches of the DC-DC converter may be controlled to control the voltage of a flying capacitor.

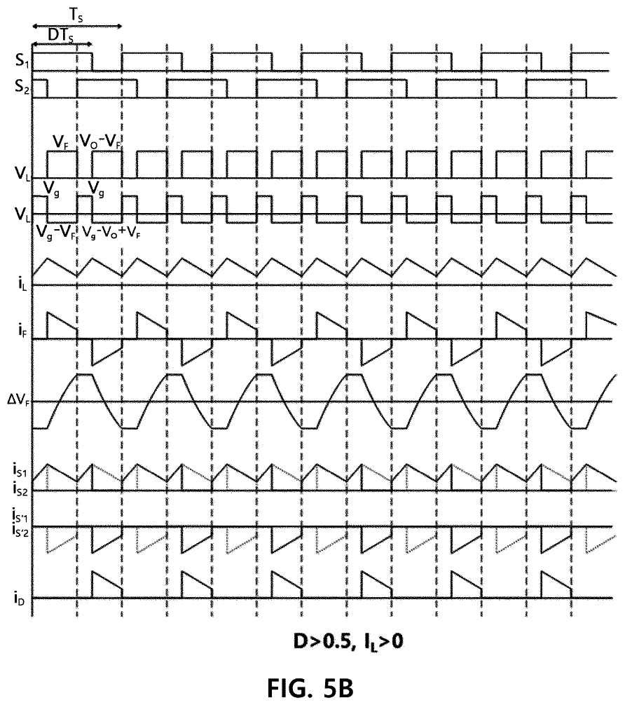

FIG. 4 shows other examples for calculating signs in the sign calculation unit 124.

FIGS. 4 (a) and (b) are examples of applying a derating factor to prevent noise that may occur due to a sudden change in sign around 0.

When the load of the DC-DC converter is a light load, it is difficult to determine the sign due to the ripple of the inductor current and the measurement error, and the change in the flying capacitor voltage according to the change in duty is very small as the load is light, and thus, control is performed by applying a derating factor as shown in FIG. 4.

In a function such as (a) of FIG. 4, the sign calculation unit 124 outputs a value i_{L}/I_{L1} obtained by dividing the inductor current by a predetermined value instead of outputting −1 or 1 if the inductor current is within a range of a predetermined value I_{L1}, that is, −I_{L1}<inductor current (i_{L})<I_{L1}.

If the inductor current is greater than or equal to I_{L1} or less than or equal to −I_{L1}, the output will be 1 or −1, which is the same as the output of the sign(x) function.

In a function like (b) of FIG. 4, if −I_{L1}≤inductor current (i_{L})<0, the output may be set to −\sqrt{−i_{L}/I_{L1}}, and if 0≤inductor current (i_{L})<I_{L1}, the output may be set to \sqrt{i_{L}/I_{L1}}.

The output generated in the sign generation unit 120 in this way is multiplied by the offset voltage generated in the voltage generation unit 110 such that the sign is changed or the offset voltage with the derating factor applied is used as an operating voltage for switch control of the DC-DC converter, and accordingly, the voltage of the flying capacitor is also controlled as targeted.

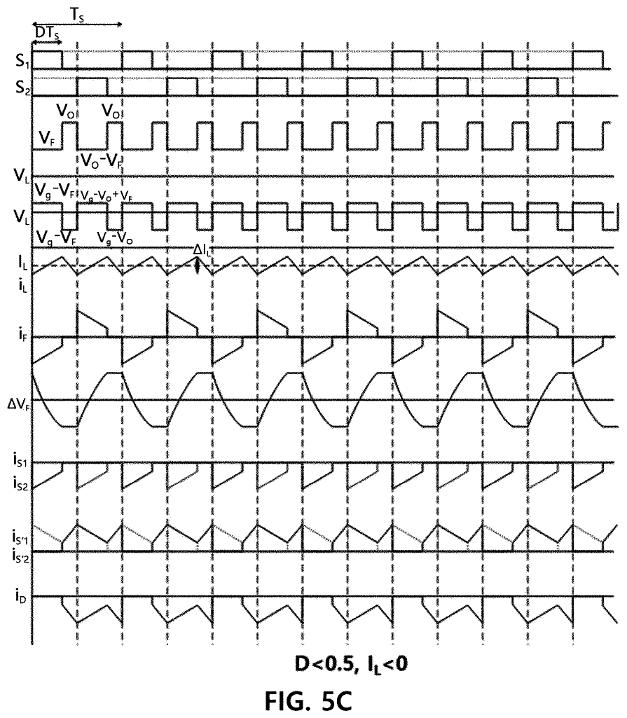

FIG. 5 shows the switching mode of a flying capacitor according to the duty ratio (D) of the switch and the inductor current direction.

FIG. 5A shows the case where D<0.5 and I_{L}>0, FIG. 5B shows the case where D>0.5 and I_{L}>0, FIG. 5C shows the case where D<0.5 and I_{L}<0, and FIG. 5D shows the case where D>0.5 and I_{L}<0.

In FIG. 5, it can be confirmed that the change in the flying capacitor voltage occurs in the opposite direction even at the same duty depending on the direction of the inductor current.

This may be expressed by the following formula:

$$Δ {V}_{F} = \frac{{I}_{L}}{s {C}_{F}}$$

From this formula, it is possible to confirm that the change in the flying capacitor voltage is in the opposite direction depending on the direction of the inductor current I_{L}.

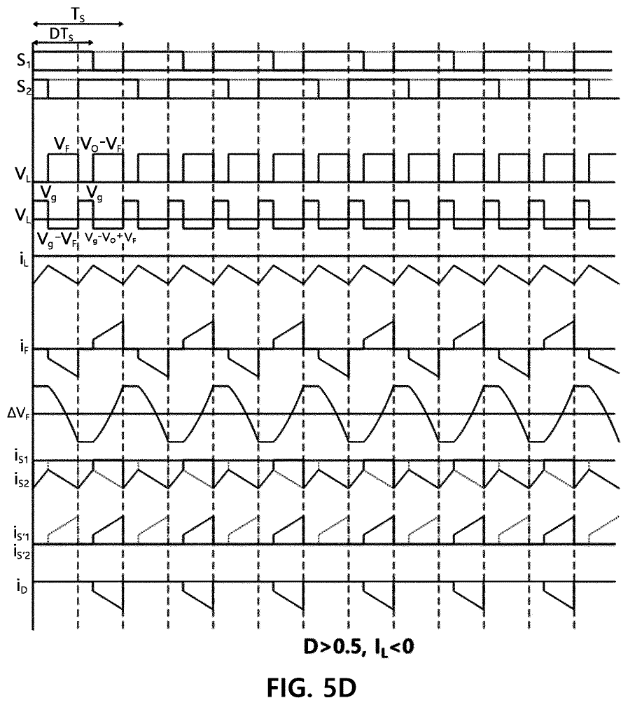

FIG. 6 shows an example in which the output voltage of a DC-DC converter and the flying capacitor voltage are controlled by an apparatus for controlling a flying capacitor voltage according to the present disclosure.

It can be confirmed that the output voltage is controlled to 1,500 V for the input voltage (1,200 V), and although the inductor current (input current) changes a direction from −66 A to 66 A, the voltage of the flying capacitor is controlled to 750 V, which is half of the output voltage, by the apparatus for controlling a flying capacitor voltage according to the present disclosure.

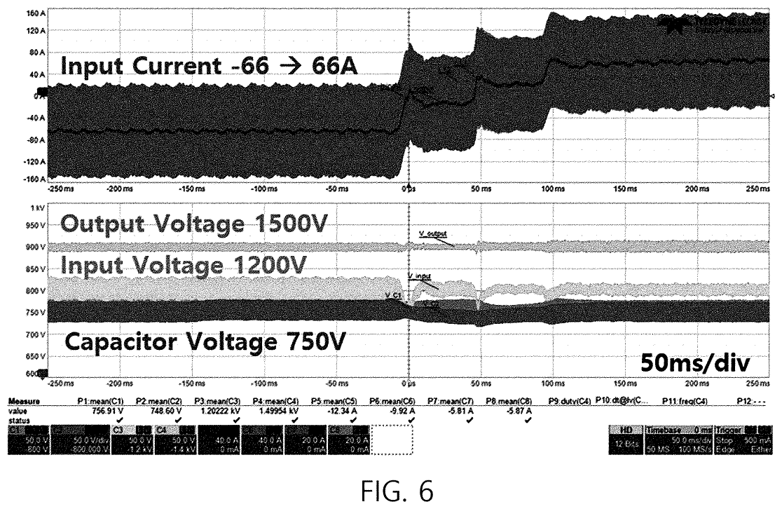

FIG. 7 is a schematic flow diagram of a method for controlling a flying capacitor voltage of a DC-DC converter according to another preferred embodiment of the present disclosure.

The method for controlling a flying capacitor voltage of a DC-DC converter according to the present disclosure may be performed by a control unit including one or more processors and a memory.

The processor may perform various operations and commands for voltage regulation, and the memory may store commands for the operation of the processor and data for voltage regulation.

In order to control the flying capacitor voltage, the voltage and current values that serve as references are input first S110.

The reference voltage includes the output voltage of the DC-DC converter and the flying capacitor voltage, and the reference current includes the inverter current of the DC-DC capacitor.

Next, an offset voltage is generated based on the input voltages S120.

The offset voltage is generated by the difference between half the DC-DC converter output voltage and the flying capacitor voltage.

For this purpose, a proportional control method or proportional-integral control method may be used, but is not limited thereto.

After generating the offset voltage, a sign control step is performed to reflect the sign of the inductor current S130.

For sign control, the sign(x) function may be used, which is a function that outputs 1 or −1 depending on the sign of the inductor current.

However, in a range where the inductor current is close to 0, accurate sign determination may not be made due to ripple of the inductor current and measurement error, and thus, a sign control value with a derating factor applied, such as the example of FIG. 4, is output.

That is, if the inductor current is within a range of a predetermined value I_{L1}, that is, −I_{L1}<inductor current (i_{L})<I_{L1}, then instead of outputting −1 or 1, the value (i_{L}/I_{L1}) obtained by dividing the inductor current by a predetermined value may be Output, or \sqrt{i_{L}/I_{L1}} or −\sqrt{−i_{L}/I_{L1}} may be output, and this is the same as explained above.

According to the apparatus and method for controlling a flying capacitor voltage of a DC-DC converter according to the present disclosure as described above, even when the direction of the inductor current is changed in a bidirectional DC-DC converter, the voltage of the flying capacitor may be stably controlled, and when the load of the DC-DC converter is a light load, even when the inductor current is a small value, the voltage of the flying capacitor may be stably controlled by reducing a measurement error.

The scope of protection of the present disclosure is not limited to the description and expression of the embodiments explicitly described above. In addition, it is added once again that the scope of protection of the present disclosure may not be limited due to obvious changes or substitutions in the technical field to which the present disclosure pertains.

1. An apparatus for controlling a flying capacitor voltage of a direct-current to direct-current (DC-DC) converter, comprising:
a voltage generation unit configured to generate an offset voltage by a difference between an output voltage of the DC-DC converter and a voltage of the flying capacitor; and
a sign control unit configured to control a sign of an offset voltage generated by the voltage generation unit according to a sign of an inductor current of the DC-DC converter.

2. The apparatus of claim 1, wherein the sign control unit multiplies the offset voltage by 1 if the inductor current is 0 or more, and multiplies the offset voltage by −1 if the inductor current is less than 0.

3. The apparatus of claim 1, wherein the sign control unit multiplies the offset voltage by a value (i_{L}/I_{L1}) obtained by dividing the inductor current by the first inductor current if the inductor current is greater than or equal to a negative first inductor current value (−I_{L1}) and less than a positive first inductor current value (+I_{L1}), multiplies the offset voltage by 1 if the inductor current is greater than or equal to +I_{L1}, and multiplies the offset voltage by −1 if the inductor current is less than −I_{L1}.

4. The apparatus of claim 1, wherein the sign control unit multiplies the offset voltage by −\sqrt{−i_{L}/I_{L1}} if the inductor current (i_{L}) is greater than or equal to a negative first inductor current value (−I_{L1}) and less than or equal to 0, multiplies the offset voltage by \sqrt{i_{L}/I_{L1}} if the inductor current is greater than 0 and less than a positive first inductor current value (I_{L1}), multiplies the offset voltage by 1 if the inductor current is greater than or equal to +I_{L1}, and multiplies the offset voltage by −1 if the inductor current is less than −I_{L1}.

5. The apparatus of claim 1, wherein the voltage generation unit is composed of a proportional control device or a proportional-integral control device.

6. A method for controlling a flying capacitor voltage of a direct-current to direct-current (DC-DC) converter performed by a control unit comprising one or more processors and a memory, the method comprising:
receiving an output voltage of the DC-DC converter and a voltage of the flying capacitor;
generating an offset voltage by a difference between an output voltage of the DC-DC converter and a voltage of the flying capacitor; and
adjusting a sign of the offset voltage according to a sign of an inductor current of the DC-DC converter.

7. The method of claim 6, wherein the adjusting a sign of the offset voltage multiplies the offset voltage by 1 if the inductor current is greater than or equal to 0, and multiplies the offset voltage by −1 if the inductor current is less than 0.

8. The method of claim 6, wherein the adjusting a sign of the offset voltage multiplies the offset voltage by −\sqrt{−i_{L}/I_{L1}} if the inductor current (i_{L}) is greater than or equal to a negative first inductor current value (−I_{L1}) and less than 0, multiplies the offset voltage by \sqrt{i_{L}/I_{L1}} if the inductor current is greater than or equal to 0 and less than a positive first inductor current value (I_{L1}), multiplies the offset voltage by 1 if the inductor current is greater than or equal to +I_{L1}, and multiplies the offset voltage by −1 if the inductor current is less than −I_{L1}.

9. The method of claim 6, wherein the adjusting a sign of the offset voltage multiplies the offset voltage by a value (i_{L}/I_{L1}) obtained by dividing the inductor current by the first inductor current if the inductor current is greater than or equal to a negative first inductor current value (−I_{L1}) and less than a positive first inductor current value (+I_{L1}), multiplies the offset voltage by 1 if the inductor current is greater than or equal to +I_{L1}, and multiplies the offset voltage by −1 if the inductor current is less than −I_{L1}.

10. The method of claim 6, wherein the generating an offset voltage generates the offset voltage by a proportional control method or a proportional-integral control method.
